(19) United States
(12) Patent Application Publication
(10) Pub. No.: US 2008/0083267 A1
(43) Pub. Date: Apr. 10, 2008

(54) Leak testing device with a permanent coupling

(76) Inventors: Joseph A. Pampinella, Chantilly, VA (US); Brandon Ming-Yung Chi, Diamond Bar, CA (US)

Correspondence Address: DINESH AGARWAL, P.C., 5350 SHAWNEE ROAD, SUITE 330, ALEXANDRIA, VA, 22312, US

(21) Appl. No.: 11/802,941

(22) Filed: May 29, 2007

Related U.S. Application Data
(63) Continuation of application No. 10/742,829, filed on Dec. 23, 2003, now abandoned.
Application No. 10/742,829 is a continuation-in-part of application No. 10/151,893, filed on May 22, 2002, now Pat. No. 6,672,139.
Application No. 10/151,893 is a continuation-in-part of application No. 09/845,217, filed on May 1, 2001, now Pat. No. 6,422,064.
Application No. 09/845,217 is a continuation-in-part of application No. 09/340,438, filed on Jun. 28, 1999, now Pat. No. 6,234,007.

(51) Int. Cl. G01M 3/08; F16L 55/11

(52) U.S. Cl. 73/49.1; 138/90

(57) ABSTRACT

A leak testing device to be positioned between two adjacent conduits comprises a generally cylindrical body defining a recess therethrough and including first and second end portions for cooperating with the respective end portions of two adjacent conduits. The body includes an opening between the first and second end portions. A sealing door is provided to be positioned in the opening. A diaphragm member including a through hole is provided to be positioned within the body. A valve is operably connected to the diaphragm member for selectively opening or closing the through hole to thereby permit or restrict the flow of a fluid between the two conduits. The opening in the body receives the diaphragm member when leak-testing a conduit, or the sealing door when connecting the two conduits in a fluid communication.

This is a continuation of pending application Ser. No. 10/742,829, filed Dec. 23, 2003, which is a continuation-in-part of application Ser. No. 10/151,893, filed on May 22, 2002 (now U.S. Pat. No. 6,672,139), which is a continuation-in-part of application Ser. No. 09/845,217, filed on May 1, 2001 (now U.S. Pat. No. 6,422,064), which is a continuation-in-part of application Ser. No. 09/340,438, filed on Jun. 28, 1999 (now U.S. Pat. No. 6,234,007), all incorporated herein in their entirety by reference.

### BACKGROUND OF THE INVENTION

The present invention is generally directed to a leak testing device, and more particularly to a leak testing device with a permanent coupling which can be positioned between two adjacent conduits, or adjacent an end of a single conduit.

In the plumbing industry, it is common to test pipes for leaks prior to use. In particular, in the installation of new plumbing systems in buildings, or the replacement of an existing pipe, the government regulations require that a pipe be leaked-tested prior to its use as part of the overall plumbing system. The current practice is to install a T-fitting between the new pipe and an existing adjacent pipe. The two arms of the T-fitting are vertically connected to the ends of the new and existing pipes with a conventional split-clamp assembly. The side-arm of the T-fitting includes a screw-on cap which can be removed for allowing access to the inside of the T (FIG. 1).

The testing procedure involves a plumbing professional to manually insert a pneumatically inflatable plug through the side-arm of the T-fitting and into the end opening of the new pipe. The plug is then inflated to seal-off the new pipe opening leading into the T-fitting. The new pipe, which in many instance extends to one or more floors of a building, is then filled with a fluid, typically water, and is left in this condition until a government official visually inspects the new pipe for any leaks. Upon completion of the inspection, the fluid from the new pipe must be discharged for final assembly of the plumbing system. The fluid discharge involves deflating the plug by actuating a valve located on the plug which is completely hidden inside the T-fitting. The access to the valve is typically gained through the side-arm of the T-fitting.

The current practice of deflating the plug and removing it from inside the T-fitting is not very desirable in that severe physical injury, including death, or property damage may result if the plug fails for any reason, or due to improper handling thereof. The inflation of the plug to a desired pressure of 30 PSI, and its deflation at the completion of the testing procedure, requires additional equipment and proper training of the associated technician. This procedure further involves the use of a T-fitting which adds to the overall expense of the testing procedure. Finally, in many instances, the inflatable plug weakens or gets damaged due to inflation and deflation and can not be reused.

In view of the above, there has been a need in the industry for a leak testing device which is safe for the plumbing professional and the surrounding property, inexpensive to manufacture, easy to use, and simple in construction. One of the co-inventors of the present invention, himself a plumbing professional for many years, responded to this long-felt need and filled the gap in the industry by devising safer leak testing devices disclosed in U.S. application Ser. Nos. 10/151,893, filed May 22, 2002, 09/845,217, filed May 1, 2001 (now U.S. Pat. No. 6,422,064) and 09/340,438, filed Jun. 28, 1999 (now U.S. Pat. No. 6,234,007), the contents of all of which are incorporated herein by reference. He also found that conventional couplings were not very effective, cumbersome to use and therefore, not desirable. In particular, a conventional coupling includes a split-clamp and separate upper and lower metallic rings to be disposed about the periphery thereof. Proper positioning and subsequent tightening of the upper and lower rings requires extra time and skill that can be eliminated.

Examples of various valves, pipe testing devices and couplings are disclosed in U.S. Pat. Nos. 1,133,714; 1,928,316; 2,823,887; 2,953,015; 3,232,577; 3,737,180; 3,770,301; 3,941,349; 3,945,604; 4,019,371; 4,124,231; 4,176,756; 4,194,721; 4,407,171; 4,429,568; 4,602,504; 4,763,510; 4,795,197; 4,819,974; 4,895,181; 5,018,768; 5,076,095; 5,197,324; 5,269,568; 5,287,730; 5,385,373; 5,707,089; 5,782,499; 6,000,278; 6,131,441; 6,299,216; 6,234,007; 6,422,064; Des. 262,133; Des. 430,482; Des. 451,984 S; and PCT International Publication WO 01/01101.

### OBJECTS AND SUMMARY OF THE INVENTION

The principal object of the present invention is to provide a leak testing device with a permanent coupling which does not suffer from the disadvantages of the conventional devices.

An object of the present invention is to provide a conduit coupling which can be easily provided between two adjacent conduits, or adjacent an end of a single conduit.

Another object of the present invention is to provide a permanent coupling for connecting two adjacent conduits in a fluid communication.

Yet another object of the present invention is to provide a leak testing device with a permanent coupling which can be easily provided between two adjacent conduits, or adjacent an end of a single conduit.

Still yet another object of the present invention is to provide a leak testing device with a permanent coupling which is safe to use in that it does not threaten physical injury to the plumbing professional, property damage, or damage to others.

An additional object of the present invention is to provide a leak testing device with a permanent coupling which eliminates the use of a T-fitting.

Yet an additional object of the present invention is to provide a leak testing device with a permanent coupling which does not require additional equipment, such as a pneumatic pump or the like for inflation and deflation purposes.

A further object of the present invention is to provide a leak testing device with a permanent coupling which is simple in construction and inexpensive to manufacture, and wherein the leak testing components, including a diaphragm with its associated parts, are reusable. In other words, after leak testing a conduit, the coupling is left in place attached to the conduit(s) for flowing a fluid therethrough, while the diaphragm and its associated components are removed and may be reused with another coupling for leak-testing another conduit.

Yet a further object of the present invention is to provide a conduit coupling for use in connection with two adjacent conduits, or a single conduit, which is versatile in that it can used with the leak testing components to leak-test a conduit, and then left in place to be used as a permanent coupling for connecting two adjacent conduits in a fluid communication subsequent to the test. In other words, the conduit coupling of the present invention is first used to leak-test a conduit in conjunction with the leak testing components, and then is left mounted at the end of a single conduit, or between two adjacent conduits for connecting the conduits in a fluid communication. In this manner, the conduit coupling functions as a permanent coupling for connecting two adjacent conduits in a fluid communication.

In summary, the main object of the present invention is to provide a leak testing device with a coupling, which can be easily installed between two adjacent conduits, or adjacent an end of a conduit. The device is simple in construction, easy to use, and does not pose danger of bodily harm to the plumbing professional and associated personnel or risk of property damage, and is inexpensive to manufacture. The coupling functions as a permanent coupling for connecting two adjacent conduits in a fluid communication, while the leak testing components are reusable.

One of the above objects is met, in part, by the present invention which in one aspect includes a coupling for connecting two adjacent conduits in a fluid communication, which comprises a generally cylindrical body defining a recess therethrough and including first and second end portions for cooperating with the respective end portions of two adjacent conduits. The body includes an opening between the first and second end portions for receiving a sealing door. The sealing door includes a through hole having a diameter generally corresponding to the internal diameter of the end portion of one of the conduits.

Another aspect of the present invention includes a coupling for connecting two adjacent conduits in a fluid communication, which comprises a generally cylindrical body defining a recess therethrough and including first and second end portions for cooperating with the respective end portions of two adjacent conduits. The body includes an opening between the first and second portions which is in communication with the recess. A sealing door including a through hole and a sealing portion is provided to be positioned in the opening. The through hole has a diameter generally corresponding to the internal diameter of the end portion of one of the conduits. The sealing portion generally corresponds in shape to the shape of the opening.

Another aspect of the present invention includes a coupling for connecting two adjacent conduits in a fluid communication, which comprises a generally cylindrical body defining a recess therethrough and including first and second end portions for cooperating with the respective end portions of two adjacent conduits. The body includes an opening between the first and second portions which is in communication with the recess. The body includes a trough which is disposed generally opposite to the opening. A sealing door including a through hole and a sealing portion is provided to be positioned in the opening.

Another aspect of the present invention includes a coupling to be positioned adjacent an end of a conduit, which comprises a generally cylindrical body defining a recess therethrough and including an end portion for cooperating with an end portion of a conduit. The body includes an opening about the circumference thereof which is in communication with the recess. A sealing door including a through hole having a diameter generally corresponding to the internal diameter of the end portion of the conduit is provided to be positioned in the opening.

Another aspect of the present invention includes a coupling to be positioned adjacent an end of a conduit, which comprises a generally cylindrical body defining a recess therethrough and including an end portion for cooperating with an end portion of a conduit. The body includes an opening about the circumference thereof which is in communication with the recess. The body includes a trough which is disposed generally opposite to the opening. A sealing door including a through hole and a sealing portion is provided to be positioned in the opening.

Another aspect of the present invention includes a leak testing device to be positioned between two adjacent conduits, which comprises a generally cylindrical body defining a recess therethrough and including first and second end portions for cooperating with the respective end portions of two adjacent conduits. The body includes an opening between the first and second end portions. A sealing door is provided to be positioned in the opening. A diaphragm member including a through hole is provided to be positioned within the body. A valve is operably connected to the diaphragm member for selectively opening or closing the through hole to thereby permit or restrict the flow of a fluid between the two conduits. The opening in the body receives the diaphragm member when leak-testing a conduit, or the sealing door when connecting the two conduits in a fluid communication.

Another aspect of the present invention includes a leak testing device to be positioned between two adjacent conduits, which comprises a generally cylindrical body defining a recess therethrough and including first and end portions for cooperating with the respective end portions of two adjacent conduits. The body includes an opening between the first and second end portions and a trough which is disposed generally opposite to the opening. A sealing door is provided to be positioned in the opening. A diaphragm member including a through hole is provided to be positioned within the body. A valve is operably connected to the diaphragm member for selectively opening or closing the through hole to thereby permit or restrict the flow of a fluid between the conduits. The opening in the body receives the diaphragm member when leak-testing a conduit, or the sealing door when connecting two conduits in a fluid communication.

Another aspect of the present invention includes a leak testing device to be positioned adjacent an end of a conduit, which comprises a generally cylindrical body defining a recess therethrough and including an end portion for cooperating with an end portion of a conduit. The body includes an opening about the circumference thereof which is in communication with the recess. A sealing door is provided to be positioned in the opening. A diaphragm member including a through hole is provided to be positioned within the body. A valve is operably connected to the diaphragm member for selectively opening or closing the through hole to thereby permit or restrict the flow of a fluid therethrough. The opening in the body receives the diaphragm member when leak-testing a conduit, or the sealing door when connecting the conduit with another conduit in a fluid communication.

Another aspect of the present invention includes a leak testing device to be positioned adjacent an end of a conduit, which comprises a generally cylindrical body defining a recess therethrough and including an end portion for cooperating with an end portion of a conduit. The body includes an opening about the circumference thereof which is in communication with the recess. The body includes a trough which is disposed generally opposite to the opening. A sealing door is provided to be positioned in the opening. A diaphragm member including a through hole is provided to be positioned within the body. A valve is operably connected to the diaphragm member for selectively opening or closing the through hole to thereby permit or restrict the flow of a fluid therethrough. The opening in the body receives the diaphragm member when leak-testing a conduit, or the sealing door when connecting the conduit with another conduit in a fluid communication.

Another aspect of the present invention includes a method of testing for a leak in a conduit, which comprises providing a first conduit to be leak-tested; providing a second conduit; and providing a leak testing device between the end portions of the first and second conduits, wherein the leak testing device comprises a generally cylindrical body defining a recess therethrough and including first and second end portions for cooperating with the respective end portion of two adjacent conduits. The body includes an opening between the first and second end portions. A sealing door is provided to be positioned in the opening. A diaphragm member including a through hole is provided to be positioned within the body. A valve is operably connected to the diaphragm member for selectively opening or closing the through hole to thereby permit or restrict the flow of a fluid between the two conduits. The opening in the body receives the diaphragm member when leak-testing a conduit, or the sealing door when connecting the two conduits in a fluid communication. The diaphragm is then positioned in the recess through the opening and the valve is actuated to restrict the flow of fluid between the first and second conduits. The first conduit is filled with a fluid and inspected for any leaks. The valve is then actuated to permit the flow of fluid from the first conduit to the second conduit.

Another aspect of the present invention includes a method of testing for a leak in a conduit, which comprises providing a first conduit to be leak-tested; providing a second conduit; and providing a leak testing device between the end portions of the first and second conduits, wherein the leak testing device comprises a generally cylindrical body defining a recess therethrough and including first and end portions for cooperating with the respective end portions of two adjacent conduits. The body includes an opening between the first and second end portions and a trough which is disposed generally opposite to the opening. A sealing door is provided to be positioned in the opening. A diaphragm member including a through hole is provided to be positioned within the body. A valve is operably connected to the diaphragm member for selectively opening or closing the through hole to thereby permit or restrict the flow of a fluid between the conduits. The opening in the body receives the diaphragm member when leak-testing a conduit, or the sealing door when connecting two conduits in a fluid communication. The diaphragm is then positioned in the recess through the opening and the valve is actuated to restrict the flow of fluid between the first and second conduits. The first conduit is filled with a fluid and inspected for any leaks. The valve is then actuated to permit the flow of fluid from the first conduit to the second conduit.

Another aspect of the present invention includes a method of testing for a leak in a conduit, which comprises providing a conduit to be leak-tested and providing a leak testing device adjacent an end of the conduit, wherein the leak testing device comprises a generally cylindrical body defining a recess therethrough and including an end portion for cooperating with an end portion of a conduit. The body includes an opening about the circumference thereof which is in communication with the recess. A sealing door is provided to be positioned in the opening. A diaphragm member including a through hole is provided to be positioned within the body. A valve is operably connected to the diaphragm member for selectively opening or closing the through hole to thereby permit or restrict the flow of a fluid therethrough. The opening in the body receives the diaphragm member when leak-testing a conduit, or the sealing door when connecting the conduit with another conduit in a fluid communication. The diaphragm is then positioned in the recess through the opening and the valve is actuated to restrict the flow of fluid through the hole. The conduit is filled with a fluid and inspected for any leaks. The valve is then actuated to permit the flow of fluid through the hole.

Another aspect of the present invention includes a method of testing for a leak in a conduit, which comprises providing a conduit to be leak-tested and providing a leak testing device adjacent an end of the conduit, wherein the leak testing device comprises a generally cylindrical body defining a recess therethrough and including an end portion for cooperating with an end portion of a conduit. The body includes an opening about the circumference thereof which is in communication with the recess. The body includes a trough which is disposed generally opposite to the opening. A sealing door is provided to be positioned in the opening. A diaphragm member including a through hole is provided to be positioned within the body. A valve is operably connected to the diaphragm member for selectively opening or closing the through hole to thereby permit or restrict the flow of a fluid therethrough. The opening in the body receives the diaphragm member when leak-testing a conduit, or the sealing door when connecting the conduit with another conduit in a fluid communication. The diaphragm is then positioned in the recess through the opening and the valve is actuated to restrict the flow of fluid through the hole. The conduit is filled with a fluid and inspected for any leaks. The valve is then actuated to permit the flow of fluid through the hole.

### BRIEF DESCRIPTION OF THE DRAWINGS

One of the above objects, advantages and novel features of the present invention will become apparent from the following detailed description of the preferred embodiment(s) of the invention, illustrated in the accompanying drawings, wherein:

FIG. 1 is a partial elevational view of a plumbing system showing a T-fitting installed between two conduits;

FIG. 2 is a perspective view showing the leak testing device of the invention installed in cooperation with two adjacent conduits;

FIG. 3 is a side elevational view of the leak testing device shown in FIG. 2;

FIG. 4 is a cross-sectional view taking along line 4-4 of FIG. 3;

FIG. 5 is an exploded view of the leak testing device shown in FIG. 2;

FIG. 6 is a cross-sectional view taken along line 6-6 of FIG. 4;

FIG. 7 is a view similar to FIG. 6, showing the leak testing device installed in cooperation with one conduit and a fluid discharge device;

FIG. 8 is top perspective view of a diaphragm member with an associated gasket for the leak testing device of the present invention;

FIG. 9 is a bottom perspective view of the diaphragm member shown in FIG. 8;

FIG. 10 is a perspective view of a sealing clip for the leak testing device of the invention;

FIG. 11 is a cross-sectional view taken along line 11-11 of FIG. 5;

FIG. 12 is a partial exploded view showing the permanent coupling of the present invention in cooperation with two adjacent conduits;

FIG. 13 is a perspective view of the permanent coupling shown in FIG. 12 connecting two adjacent conduits in a fluid communication;

FIG. 14 is a cross-sectional view taken along line 14-14 of FIG. 13;

FIG. 15 is a view similar to FIG. 2, showing a first alternative embodiment of the leak testing device;

FIG. 16 is a cross-sectional view taken along line 16-16 of FIG. 15;

FIG. 17 is a cross-sectional view taken along line 17-17 of FIG. 16;

FIG. 18 is an exploded view of the leak testing device shown in FIG. 15;

FIG. 19 is a cross-sectional view taken along line 19-19 of FIG. 18;

FIG. 20 is a partial exploded view showing a first alternative embodiment of the permanent coupling of the present invention in cooperation with two adjacent conduits;

FIG. 21 is a perspective view of the permanent coupling shown in FIG. 20 connecting two adjacent conduits in a fluid communication; and

FIG. 22 is a cross-sectional view taken along line 22-22 of FIG. 21.

### DETAILED DESCRIPTION OF THE PREFERRED EMBODIMENT(S)

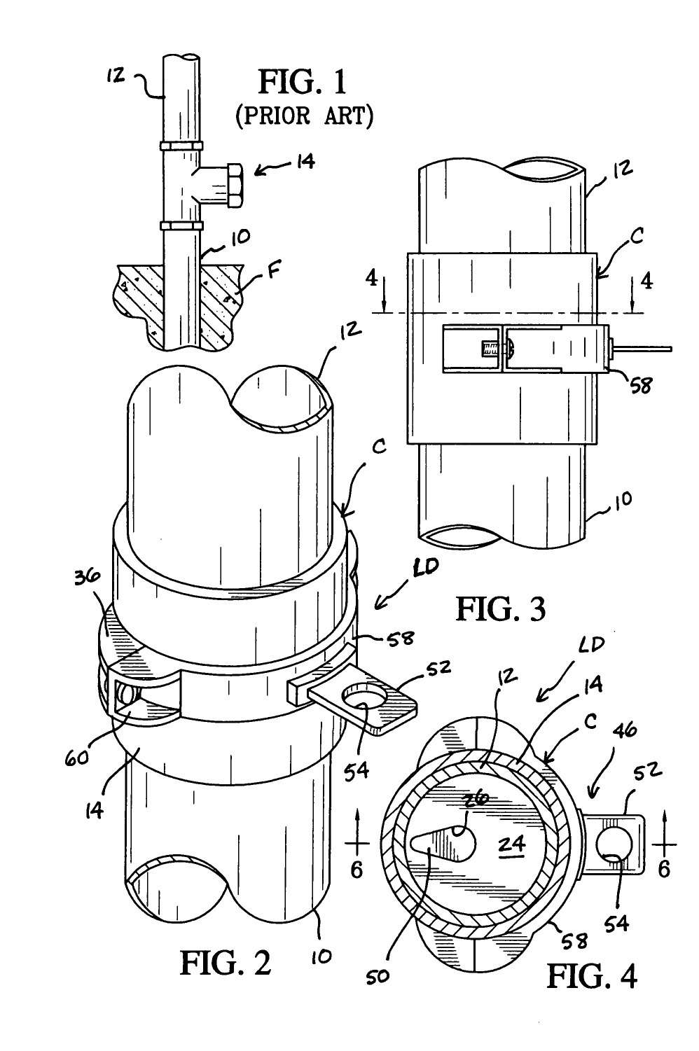

As illustrated in FIG. 1, the leak testing device LD of the present invention is used in connection with an existing pipe or conduit 10 extending from a floor F or the like, and a new pipe 12. Conventionally, a T-fitting 14 is provided between the existing and new pipes 10 and 12, respectively, prior to testing the new pipe 12 for any leaks. The leak testing device LD of the present invention is preferably used without a T-fitting, as shown in FIG. 2.

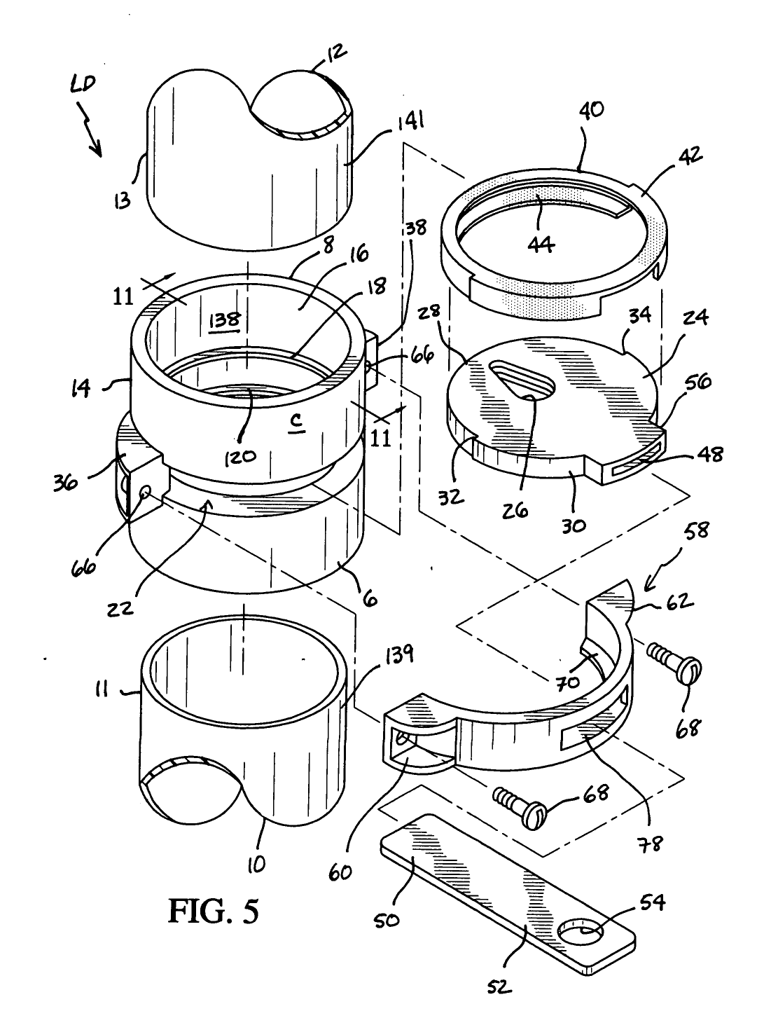

As best shown in FIGS. 4-5 and 11, the leak testing device LD includes a coupling C in the form of a generally cylindrical body 14 which defines therein a recess 16 between open end portions 6 and 8 thereof. As best illustrated in FIGS. 5 and 11, upper and lower shoulder or lip portions 18 and 20 extend radially into the recess 16, and preferably extend throughout the internal perimeter of the body portion 14. In other words, upper and lower shoulder portions 18 and 20 are preferably in the form of axially-spaced internal rings that extend radially into the recess 16. (It is noted herewith that the shoulder portions 18 and 20 may alternatively be in the form of one or more circumferentially spaced tabs that extend into the recess 16 from the internal perimeter of the body 14). The body 14 includes a generally crescent-shaped side opening 22 that is in communication with the recess 16. Preferably, the side opening 22 extends about half-way around the circumference of the body 14 (FIG. 5).

As best shown in FIGS. 5 and 8-9, a generally circular diaphragm member 24, with a through hole 26 is provided to be received between the upper and lower shoulder portions 18 and 20 through the side opening 22. As shown in FIG. 5, the diaphragm member 24 includes a rounded front end portion 28 of a diameter somewhat less than the diameter of a rounded rear end portion 30. The front and rear end portions 28 and 30 define left and right steps 32 and 34 that abut corresponding left and right locking tabs 36 and 38 on the body 14. In this manner, the steps 32 and 34 function as stops for the diaphragm member 24 when inserting through the side opening 22. In order to provide a fluid-tight engagement between the diaphragm member 24 and the upper and lower shoulder portions 18 and 20, a generally ring-shaped gasket 40, preferably made of a resilient or compressible material, is snap-fitted on the diaphragm member 24. As best shown in FIGS. 8 and 9, the overall configuration of the gasket 40 generally corresponds to the overall configuration of the diaphragm member 24. The gasket 40 includes upper and lower lips 42 and 44 for securing the gasket 40 on the diaphragm member 24. In this regard, it is noted that the overall thickness T₁ of the diaphragm member 24 with the associated gasket 40, is preferably slightly more than the distance D₁ between the upper and lower shoulder portions 18 and 20 to ensure a tight frictional engagement therebetween (FIGS. 8 and 11).

As best shown in FIGS. 4-6 and 8, a valve assembly 46 includes a radially extending recess 48 in the diaphragm member 24 for receiving a valve member 50 therein. The valve member 50 is preferably integral with a valve handle 52 positioned externally of the body 14. The recess 48 is in fluid communication with the diaphragm hole 26. A hole 54 is provided in the valve handle 52 for the ease of holding and actuation thereof.

The diaphragm member 24 includes a somewhat square-shaped extension 56 that extends from the rear end portion 30 thereof. When the diaphragm member 24 is inserted through the side opening 22 of the body 14, the rear end portion 30 thereof is preferably flush with the external periphery of the body 14, while the extension 56 projects outwardly for the ease of manipulating the valve handle 52.

In order to secure the diaphragm member 24 in the body 14 and to provide a fluid-tight engagement therebetween, a generally semi-circular sealing clip 58 is provided (FIGS. 5 and 10). The clip 58 includes left and right tabs 60 and 62 that come to abut corresponding left and right tabs 36 and 38 of the body 14. Each of the left and right tabs 60 and 62 includes a hole 64 that is in alignment with the corresponding screw-threaded hole 66 in the tabs 36 and 38. Conventional partially screw-threaded fasteners 68 are provided through the holes 64 to be screw-threaded in the corresponding screw-threaded holes 66 for interlocking the clip 58 with the body 14.

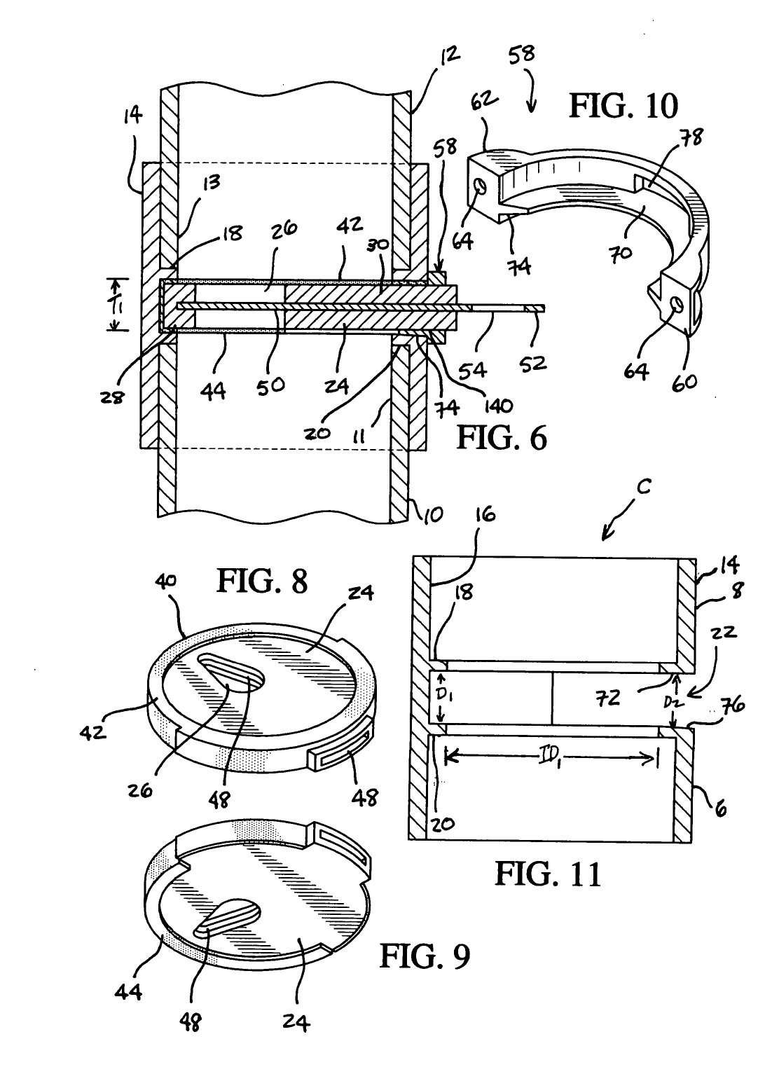

As best shown in FIGS. 6 and 10, the sealing clip 58 includes an internal, radially extending lip 70 which functions as a cam to bias the diaphragm member 24 upwardly to compress the upper lip 42 of the gasket 40 against the surface 72 of the upper shoulder portion 18. The lower surface 74 of the lip 70 is somewhat tapered to firmly engage the corresponding tapered surface 76 of the lower shoulder portion 20. The sealing clip 58 includes a generally rectangularly-shaped side hole 78 for receiving the correspondingly shaped extension 56 of the diaphragm member 24.

As described below, once the testing of a pipe or conduit is completed for leaks, the diaphragm member 24, along with the valve assembly 46 and the sealing clip 58, is removed from the body 14, but the conduit coupling C is left in position to connect the adjacent conduits 10 and 12 in a fluid communication. In order to prevent fluid leakage through the side opening 22, a sealing door 80 is provided.

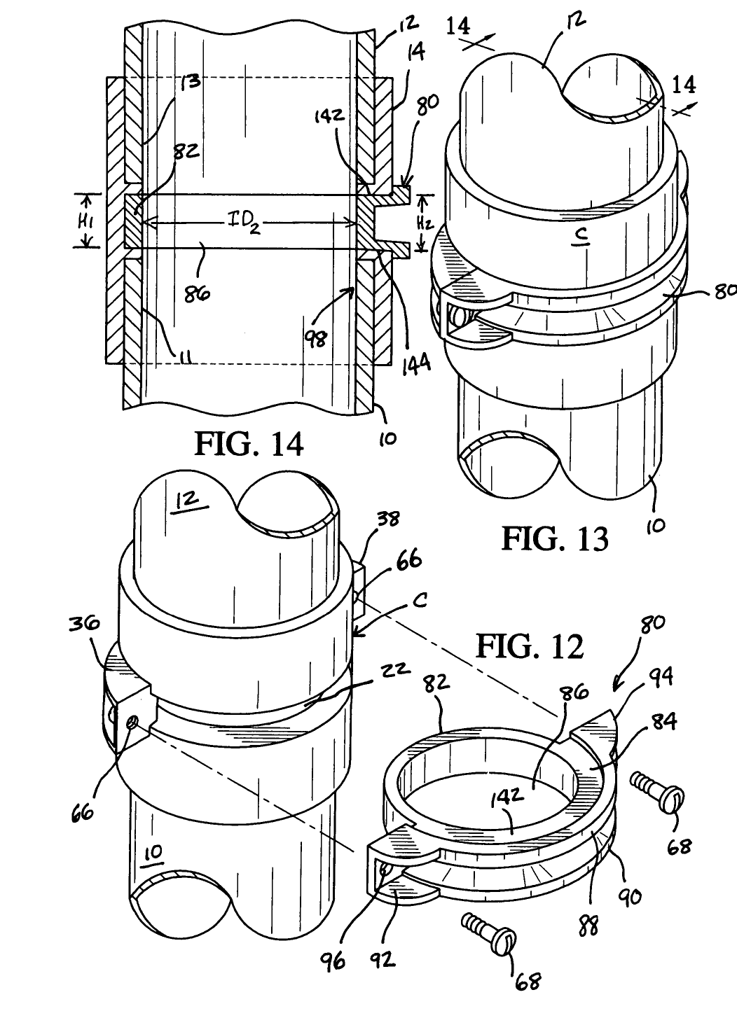

As best shown in FIG. 12, the sealing door 80 includes a front rounded or generally ring-shaped fluid-flow portion 82 and a rear sealing portion 84. The fluid-flow portion 82 and the sealing portion 84 define therebetween a through hole 86 that generally corresponds in diameter to the internal diameter of the end portion of one (or both) of the conduits 10 and 12.

As best shown in FIG. 14, the fluid-flow portion 82 has a vertical height H₁ that generally corresponds to the distance D₁ (FIG. 11) between the upper and lower shoulder portions 18 and 20 for a tight frictional engagement therebetween. Likewise, the vertical height H₂ of the sealing portion 84 (being slightly more than H₁) generally corresponds to the distance D₂ between upper and lower shoulder portions 18 and 20 adjacent the side opening 22. The sealing door 80 includes handles 88 and 90 for the ease of inserting the sealing door 80 through the side opening 22 and removal therefrom. The sealing door 80 also includes tabs 92 and 94, each with a hole 96, that come to abut corresponding tabs 36 and 38 on the body 14.

As best shown in FIGS. 8 and 11, the internal diameter of the body 14 (or the diameter of recess 16) generally corresponds to, or is slightly larger than, the external diameter of the end portions 11 and 13 the conduits 10 and 12, respectively, for a fluid-tight engagement therebetween. However, it is noted that the internal diameter ID₁ of the recess 16, as defined by the upper and lower shoulder portions 18 and 20, generally corresponds to the internal diameter of the end portions 11 and 13 of the conduits 10 and 12. Likewise, the internal diameter ID₂ of the hole 86 in the sealing door 80 generally corresponds to the internal diameter of the end portions 11 and 13 of the conduits 10 and 12 (FIG. 14). In this manner, when the sealing door 80 is installed, a generally continuous, uninterrupted fluid flow surface 98 is provided from one conduit to the other.

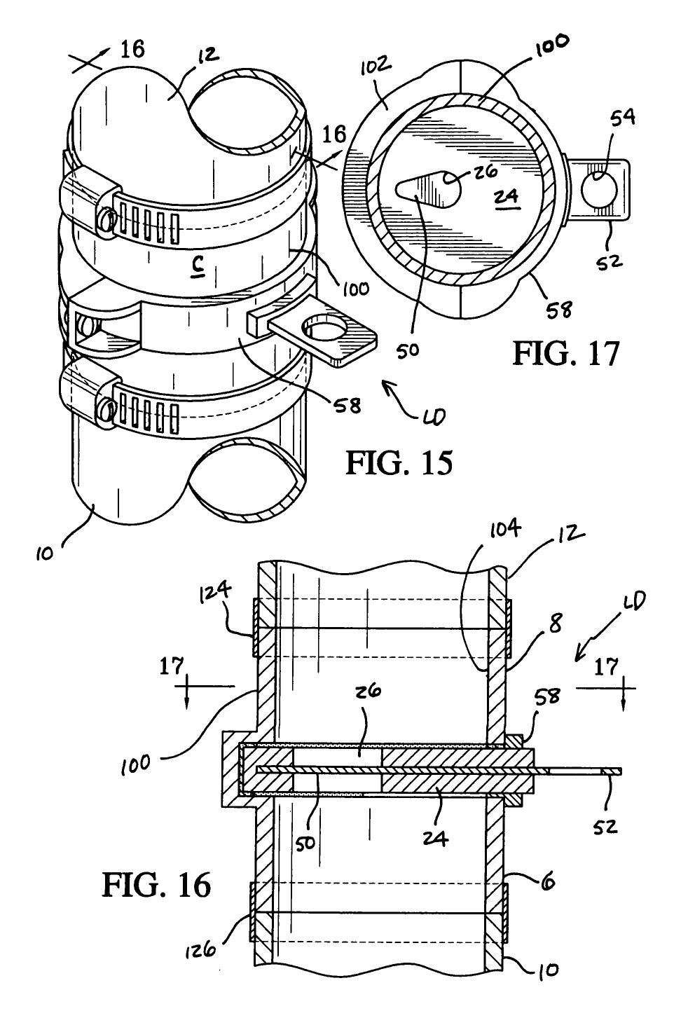

FIGS. 15-22 illustrate an alternative embodiment of the leak testing device LD of the invention, which is similar to the embodiment illustrated in FIGS. 2-14, with the exception that the coupling C is provided with a trough in place of the upper and lower shoulder portions 18 and 20, and the sealing door construction is slightly different. In addition, the end portions 6 and 8 of the coupling C generally correspond in diameter to the end portions 11 and 13 of the conduits 10 and 12. (It is noted herewith that in the alternative embodiment, like parts are designated with the same reference numerals as in the embodiment shown in FIGS. 2-14).

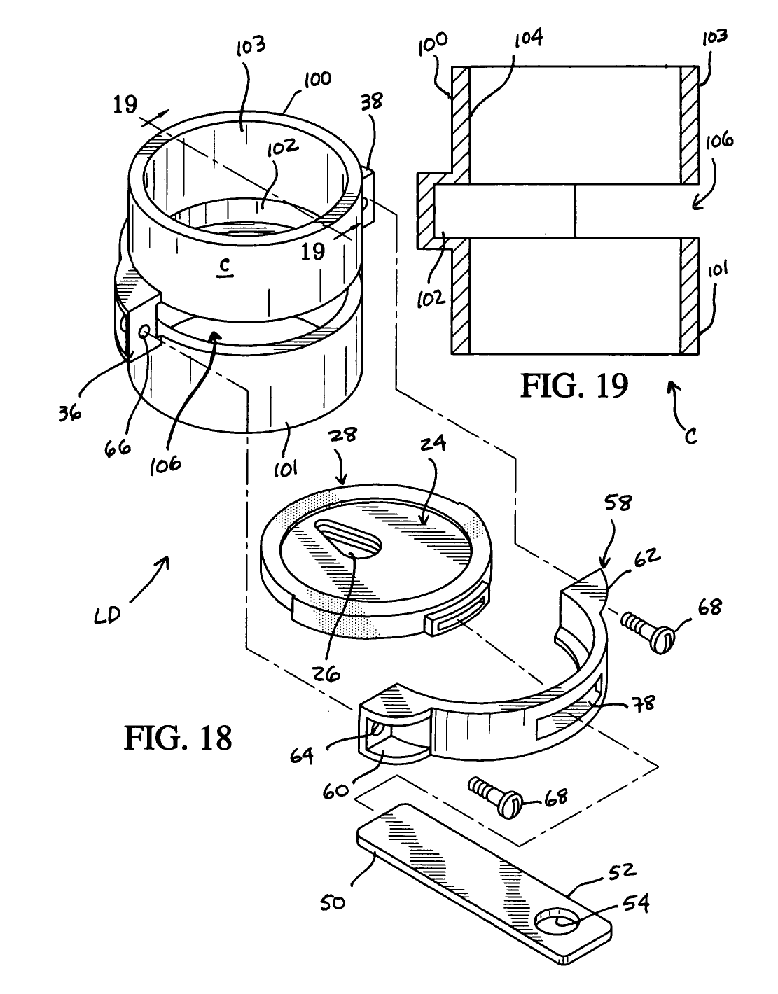

As best shown in FIGS. 18-19, the coupling C is in the form of a cylindrical body 100 including a trough 102 that extends outwardly from the recess 104. The trough 102 preferably extends about half-way around the circumference of the body 100 and is disposed generally opposite a generally crescent-shaped side opening 106. The side opening 106 also preferably extends about half-way around the circumference of the body 100 and is in fluid communication with the recess 104. The shape and configuration of the trough 102 corresponds to the front end portion 28 of the diaphragm member 24 for providing a secure and fluid-tight engagement therebetween.

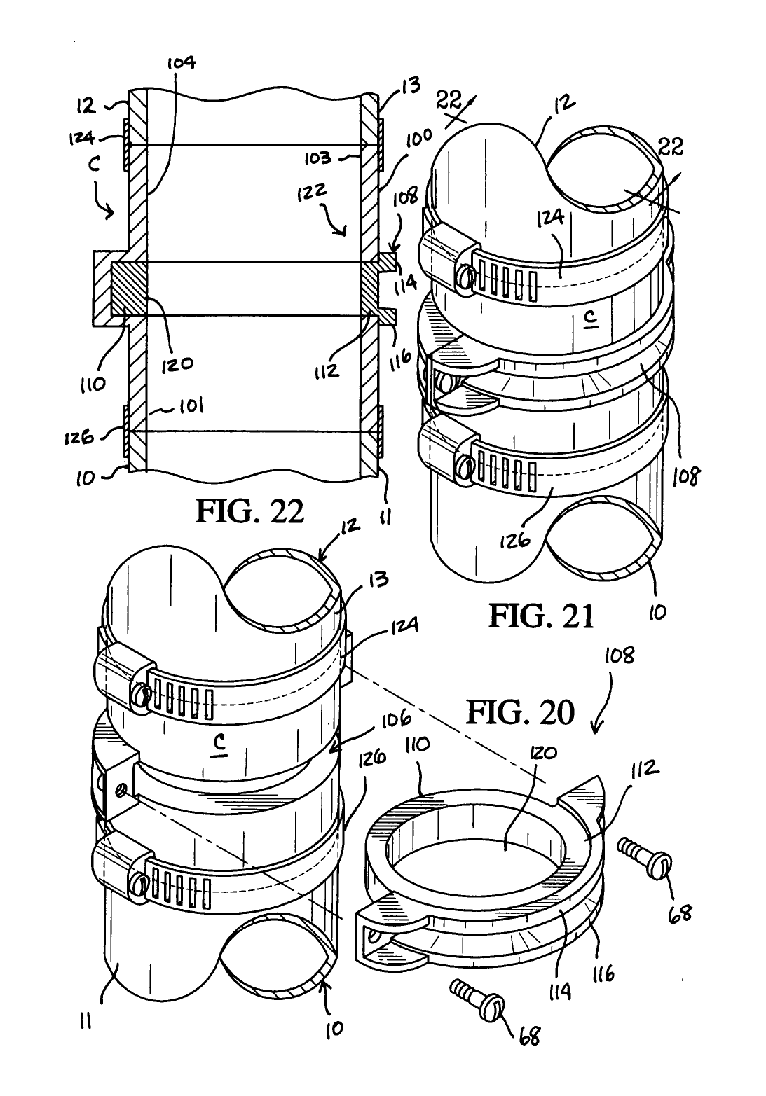

With respect to the sealing door 108, it has the same overall configuration as the sealing door 80, with the exception that the front fluid-flow portion 110 is thicker to be accommodated in the trough 102, and the rear sealing portion 112 is of the same general thickness as the body 100 (FIGS. 20 and 22). The sealing door 108 also includes handles 114 and 116. The through hole 120 in the sealing door 108, defined by the front and rear portions 110 and 112, has a diameter generally corresponding to the diameter of the recess 104.

It is noted that the diameter of the recess 104 in the coupling C generally corresponds to the internal diameter of the end portion of one (or both) the conduits 10 and 12. Accordingly, as in the embodiment illustrated in FIGS. 2-14, a generally continuous, uninterrupted fluid flow surface 122 is also provided from one conduit to the other, when the sealing door 108 is positioned in the side opening 106.

In order to secure the conduits 10 and 12 to the coupling C, conventional split-clamp assemblies 124 and 126 are provided (FIGS. 20-22).

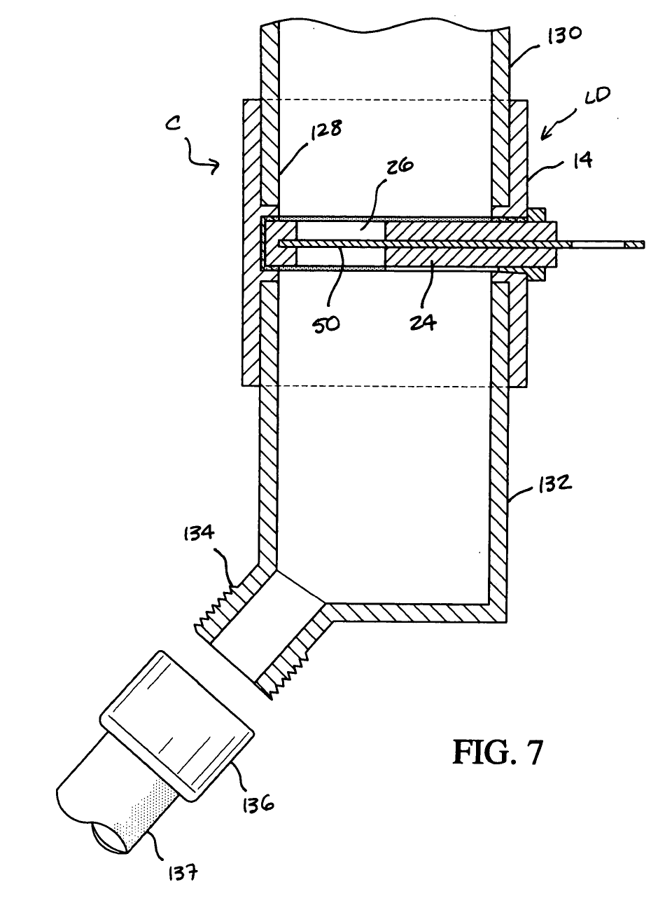

FIG. 7 illustrates the leak testing device LD, shown in FIGS. 2-6 and 8-14, installed adjacent an end 128 of a single conduit 130. This type of arrangement is generally useful for leak testing a conduit by installing one leak testing device LD of the invention at each end thereof, or where, for example, the conduit extends down through a ceiling.

As shown, the leak testing device LD is positioned adjacent the single conduit 128 and a fluid discharge conduit 132. The fluid discharge conduit 132 includes a screw-threaded nipple 134 for cooperating with the coupling 136 of, for example, a garden hose 137. It is noted herewith that the leak testing device LD, shown in FIGS. 15-22, may also be used with a single conduit, in the same manner.

The coupling C, sealing clip 58, sealing door 80, the diaphragm member 24, and the valve member 50 with valve handle 52, may all be made of a rigid material, such as hard plastic, metal, PVC, etc. It is preferable, however, that the coupling C shown in FIGS. 15-22 be made of cast iron or steel.

### Use and Operation

Referring now to FIGS. 2-6 and 8-11, when it is desired to test the leak integrity of a new pipe 12, the leak testing device LD of the present invention is provided such that the respective end portions 11 and 13 of the existing and new pipes 10 and 12, respectively, are slidably received in the end portions 6 and 8 of the body 14 and into the recess 16. Prior to positioning the end portions 11 and 13, a suitable adhesive, such as a PVC cement, is applied on the internal surface 138 of the body 14 and/or the outer surfaces 139 and 141 of the end portions 11 and 13, to provide a permanent seal between the end portions 6 and 8 of the body 14 and the end portions 11 and 13 of the pipes 10 and 12. As best shown in FIG. 8, the end portion 11 of the pipe 10 would sealingly engage the lower shoulder portion 20, while the end portion 13 of the pipe 12 would sealingly engage the upper shoulder portion 18. The diaphragm member 24 is then positioned in the recess 16 by inserting through the side opening 22 such that the front and rear end portions 28 and 30 are sealingly received between the upper and lower shoulder portions 18 and 20. The sealing clip 58 is then positioned in the side opening 22 such that the lip 70 thereof is snugly received between the lower surface 140 of the diaphragm member 24 and the surface 76 of the lower shoulder portion 20. The fasteners 68 are then positioned through the holes 64 in the sealing clip 58 to be received in the corresponding holes 66 in the tabs 36 and 38 to firmly secure the sealing clip 58 to the body 14 in a known manner. The valve handle 52 is then actuated to close the through hole 26 in the diaphragm member 24.

Upon assuring that the leak testing device LD is in proper fluid-tight engagement with the pipe end portions 11 and 13, the pipe 12 is then filled with a fluid and allowed to stand until the inspection for any leaks is completed. Upon completion of the inspection, the valve handle 52 is carefully and slowly pulled outwardly to allow gradual flow of fluid from the new pipe 12 into the existing pipe 10. Upon assuring that the pipe 12 is substantially empty of the fluid, the fasteners 68 are unscrewed and the sealing clip 58 is removed from the body 14. The diaphragm member 24 is pulled outwardly and removed from the body 14.

In order to connect the two pipes 10 and 12 in a fluid communication, the side opening 22 is sealed by inserting therethrough the sealing door 80. Prior to positioning the sealing door 80 in the side opening 22, however, a suitable adhesive, such as a PVC cement, may be applied on the upper and lower surfaces 142 and 144 of the sealing portion 84 thereof. The fasteners 68 are then threaded through the holes 96 to be screw-threaded in the corresponding holes 66 in the locking tabs 36 and 38 to permanently secure the sealing door 80 to the coupling C (FIG. 13).

The manner of installation and use of the embodiment shown in FIGS. 15-22, is similar as described above with reference to FIGS. 1-8 and 8-14. It would be appreciated, however, that the diaphragm member 24 would be inserted through the side opening 106 such that the front end portion 28 thereof is frictionally received in the trough 102 in a fluid-tight manner. The sealing clip 58 is then positioned in the same manner, as noted above. Once the inspection is completed, the diaphragm member 24 would be removed from the side opening 106 and the sealing door 108 positioned in the same manner, as described above. It is further noted, however, that since the end portions 11 and 13 of the pipes 10 and 12 generally correspond in diameter to the end portions 101 and 103 of the body 100, split-clamp assembly 124 and 126 are used in a known manner to secure the coupling C between the pipes 10 and 12.

When using the leak testing device LD of the present invention adjacent a single conduit 130 (FIG. 7), it would be appreciated that while the end portion 128 of the conduit 130 would be permanently mounted to the body 14 by providing an adhesive therebetween, the mounting of the fluid discharge conduit 132 to the body 14 would not be permanent such that when the inspection is completed, the fluid discharge conduit 132 may be removed from the body 14 to be replaced by another pipe or conduit to connect it with the conduit 130 in a fluid communication. During testing, however, the fluid from the conduit 130 may be discharged through the garden hose 137 (or similar conduit) via discharge conduit 132.

It can be observed from the above that the coupling C of the present invention is mounted permanently between two adjacent conduits or pipes for testing purposes, however, it is left in place to connect the two conduits in a fluid communication subsequent to the testing. On the other hand, the diaphragm member 24 with the valve assembly 46, and the sealing clip 58 are removed after the testing and can be used to leak-test another conduit. Thus, the diaphragm and sealing clip are reusable, while the coupling C permanently connects two conduits in a fluid communication.

As can also be seen from the above, since the opening and closing of the valve assembly 46, is done completely external of the pipes 10 and 12, and the fluid flows only between the pipes 10 and 12, the leak testing device LD of the present invention poses no danger to the personnel or the property involved. In addition, the operation of the leak testing device LD of the present invention does not require any additional equipment, such as a pneumatic pump or the like, and thus the entire procedure is straightforward, fast and significantly less complicated than the conventional devices. Finally, since the leak testing device LD of the present invention does not require the use of a T-fitting, significant savings in terms of time and expense are achieved.

While this invention has been described as having preferred sequences, ranges, steps, materials, structures, features, and/or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention and of the limits of the appended claims.

What is claimed is:

1. A coupling for connecting two adjacent conduits in a fluid communication, comprising:
a) a generally cylindrical body defining a recess therethrough;
b) said body including first and second end portions for cooperating with the respective end portions of two adjacent conduits;
c) said body including an opening between said first and second end portions for receiving a sealing door; and
d) said sealing door including a through hole having a diameter generally corresponding to the internal diameter of the end portion of one of the conduits.

2. The coupling of claim 1, wherein:
a) said body includes a shoulder portion extending into said recess; and
b) said sealing door includes an end portion for positioning over said shoulder portion.

3. The coupling of claim 2, wherein:
a) said shoulder portion extends about the perimeter of said body.

4. The coupling of claim 3, wherein:
a) said shoulder portion defines a central opening having a diameter generally corresponding to the diameter of the through hole in said sealing door.

5. The coupling of claim 1, wherein:
a) said body includes first and second axially spaced shoulder portions extending into said recess; and
b) said sealing door includes an end portion for positioning between said first and second shoulder portions.

6. The coupling of claim 1, wherein:
a) the opening extends through the thickness of said body and is generally crescent-shaped; and
b) said sealing door includes a sealing portion generally corresponding in shape to the shape of the opening.

7. The coupling of claim 6, wherein:
a) the opening extends partially about the circumference of said body.

8. The coupling of claim 7, wherein:
a) the opening extends about half-way around the circumference of said body.

9. The coupling of claim 1, wherein:
a) the internal diameter of one of said end portions is larger than the external diameter of the end portion of one of the conduits.

10. The coupling of claim 1, wherein:
a) the internal diameter of one of said end portions is generally the same as the internal diameter of the end portion of one of the conduits.

11. The coupling of claim 1, further comprising:
a) a locking member for fastening said sealing door with said body.

12. A coupling for connecting two adjacent conduits in a fluid communication, comprising:
a) a generally cylindrical body defining a recess therethrough;
b) said body including first and second end portions for cooperating with the respective end portions of two adjacent conduits;
c) said body including an opening between said first and second end portions and in communication with said recess;
d) a sealing door to be positioned in the opening;
e) said sealing door including a through hole and a sealing portion;
f) the through hole having a diameter generally corresponding to the internal diameter of the end portion one of the conduits; and
g) said sealing portion generally corresponding in shape to the shape of the opening.

13. The coupling of claim 12, wherein:
a) said body includes a shoulder portion extending into said recess; and
b) said sealing door includes an end portion for positioning over said shoulder portion.

14. A coupling of claim 13, wherein:
a) said shoulder portion extends about the perimeter of said body and defines a central opening having a diameter generally corresponding to the diameter of the through hole in said sealing door.

15. The coupling of claim 12, wherein:
a) the opening extends partially about the circumference of said body.

16. The coupling of claim 15, wherein:
a) the opening extends about half-way around the circumference of said body.

17. A coupling for connecting two adjacent conduits in a fluid communication, comprising:
a) a generally cylindrical body defining a recess therethrough;
b) said body including first and second end portions for cooperating with the respective end portions of two adjacent conduits;
c) said body including an opening between said first and second end portions and in communication with said recess;
d) said body including a trough disposed generally opposite the opening;
e) a sealing door to be positioned in the opening; and
f) said sealing door including a through hole and a sealing portion.

18. The coupling of claim 17, wherein:
a) the opening extends partially about the circumference of said body.

19. The coupling of claim 18, wherein:
a) the opening extends about half-way around the circumference of said body.

20. The coupling of claim 17, wherein:
a) said trough extends partially about the circumference of said body.

21. The coupling of claim 20, wherein:
a) said trough extends about half-way around the circumference of said body.

22. The coupling of claim 17, wherein:
a) said trough is disposed externally of said body.

23. The coupling of claim 17, wherein:
a) said sealing door includes a fluid-flow portion including the through hole; and
b) said fluid-flow portion including an end portion to be received in said trough.

24. The coupling of claim 23, wherein:
a) the diameter of the through hole generally corresponds to the internal diameter of the end portion of one of the conduits.

25. The coupling of claim 24, wherein:
a) the diameter of said recess generally corresponds to the diameter of the through hole.

26. The coupling of claim 23, wherein:
a) said end portion of said fluid-flow portion has a thickness greater than the thickness of said sealing portion.

27. The coupling of claim 17, further comprising:
a) a locking member for fastening said sealing door with said body.

28. A coupling to be positioned adjacent an end of a conduit, comprising:
a) a generally cylindrical body defining a recess therethrough;
b) said body including an end portion for cooperating with an end portion of a conduit;
c) said body including an opening about the circumference thereof and in communication with said recess;
d) a sealing door to be positioned in the opening; and
e) said sealing door including a through hole having a diameter generally corresponding to the internal diameter of the end portion of the conduit.

29. A coupling to be positioned adjacent an end of a conduit, comprising:
a) a generally cylindrical body defining a recess therethrough;
b) said body including an end portion for cooperating with an end portion of a conduit;
c) said body including an opening about the circumference thereof and in communication with said recess;
d) said body including a trough disposed generally opposite the opening;
e) a sealing door to be positioned in the opening; and
f) said sealing door including a through hole and a sealing portion.

30. A leak testing device to be positioned between two adjacent conduits, comprising:
a) a generally cylindrical body defining a recess therethrough;
b) said body including first and second end portions for cooperating with the respective end portions of two adjacent conduits;
c) said body including an opening between said first and second end portions;
d) a sealing door to be positioned in the opening;
e) a diaphragm member to be positioned within said body;
f) said diaphragm member including a through hole;
g) a valve operably connected to said diaphragm member for selectively opening or closing the through hole to thereby permit or restrict the flow of a fluid between the conduits; and
h) the opening in said body receiving said diaphragm member when leak-testing a conduit, or said sealing door when connecting two conduits in a fluid communication.

31. The leak testing device of claim 30, wherein:
a) said body includes a shoulder portion extending into said recess.

32. The leak testing device of claim 31, wherein:
a) said diaphragm member includes an end portion for positioning over said shoulder portion.

33. The leak testing device claim 32, wherein:
a) the radius of curvature of said end portion is smaller than the radius of curvature of the remaining portion of said diaphragm member.

34. The leak testing device of claim 32, wherein:
a) said body includes first and second axially spaced shoulder portions; and
b) said end portion of said diaphragm member is positioned between said first and second shoulder portions.

35. The leak testing device of claim 31, wherein:
a) said sealing door includes an end portion for positioning over said shoulder portion.

36. The leak testing device of claim 35, wherein:
a) said body includes first and second axially spaced shoulder portions; and
b) said end portion is positioned between said first and second shoulder portions.

37. The leak testing device of claim 31, wherein:
a) said sealing door includes a through hole having a diameter generally corresponding to the internal diameter of the end portion of one of the conduits.

38. The leak testing device of claim 37, wherein:
a) said shoulder portion extends about the perimeter of said body.

39. The leak testing device of claim 38, wherein:
a) said shoulder portion defines a central opening having a diameter generally corresponding to the diameter of the hole in said sealing door.

40. The leak testing device of claim 30, wherein:
a) the opening extends through the thickness of said body and is generally crescent-shaped; and
b) said sealing door includes a sealing portion generally corresponding in shape to the shape of the opening.

41. The leak testing device of claim 40, wherein:
a) the opening extends partially about the circumference of said body.

42. The leak testing device of claim 41, wherein:
a) the opening extends about half-way around the circumference of said body.

43. The leak testing device of claim 30, wherein:
a) the internal diameter of one of said end portions is larger than the external diameter of the end portion of one of the conduits.

44. The leak testing device of claim 30, wherein:
a) the internal diameter of one of said end portions is generally the same as the internal diameter of the end portion of one of the conduits.

45. The leak testing device of claim 30, further comprising:
a) a locking member for fastening said sealing door with said body.

46. A leak testing device to be positioned between two adjacent conduits, comprising:
a) a generally cylindrical body defining a recess therethrough;
b) said body including first and second end portions for cooperating with the respective end portions of two adjacent conduits;
c) said body including an opening between said first and second end portions;
d) said body including a trough disposed generally opposite the opening;
e) a sealing door to be positioned in the opening;
f) a diaphragm member to be positioned within said body;
g) said diaphragm member including a through hole;
h) a valve operably connected to said diaphragm member for selectively opening or closing the through hole to thereby permit or restrict the flow of a fluid between the conduits; and
i) the opening in said body receiving said diaphragm member when leak-testing a conduit, or said sealing door when connecting two conduits in a fluid communication.

47. The leak testing device of claim 46, wherein:
a) the opening extends partially about the circumference of said body.

48. The leak testing device of claim 47, wherein:
a) the opening extends about half-way around the circumference of said body.

49. The leak testing device of claim 46, wherein:
a) said trough extends partially about the circumference of said body.

50. The leak testing device of claim 49, wherein:
a) said trough extends about half-way around the circumference of said body.

51. The leak testing device of claim 49, wherein:
a) said trough is disposed externally of said body.

52. The leak testing device of claim 46, wherein:
a) said sealing door includes a fluid-flow portion including the through hole; and
b) said fluid-flow portion including an end portion to be received in said trough.

53. The leak testing device of claim 52, wherein:
a) the diameter of the through hole generally corresponds to the internal diameter of the end portion of one of the conduits.

54. The leak testing device of claim 53, wherein:
a) the diameter of said recess generally corresponds to the diameter of the through hole.

55. The leak testing device of claim 52, wherein:
a) said end portion of said fluid-flow portion has a thickness greater than the thickness of said sealing portion.

56. The leak testing device of claim 46, further comprising:
a) a locking member for fastening said sealing door with said body.

57. A leak testing device to be positioned adjacent an end of a conduit, comprising:
a) a generally cylindrical body defining a recess therethrough;
b) said body including an end portion for cooperating with an end portion of a conduit;
c) said body including an opening about the circumference thereof and in communication with said recess;
d) a sealing door to be positioned in the opening;
e) a diaphragm member to be positioned within said body;
f) said diaphragm member including a through hole;
g) a valve operably connected to said diaphragm member for selectively opening or closing the through hole to thereby permit or restrict the flow of a fluid therethrough; and
h) the opening in said body receiving said diaphragm member when leak-testing a conduit, or said sealing door when connecting the conduit with another conduit in a fluid communication.

58. The leak testing device of claim 57, wherein:
a) said sealing door includes a through hole and a sealing portion.

59. The leak testing device of claim 58, wherein:
a) the diameter of the through hole in said sealing door generally corresponds to the internal diameter of the end portion of the conduit.

60. A leak testing device to be positioned adjacent an end of a conduit, comprising:
a) a generally cylindrical body defining a recess therethrough;
b) said body including an end portion for cooperating with an end portion of a conduit;
c) said body including an opening about the circumference thereof and in communication with said recess;
d) said body including a trough disposed generally opposite the opening;
e) a sealing door to be positioned in the opening;
f) a diaphragm member to be positioned within said body;
g) said diaphragm member including a through hole;
h) a valve operably connected to said diaphragm member for selectively opening or closing the through hole to thereby permit or restrict the flow of a fluid therethrough; and
i) the opening in said body receiving said diaphragm member when leak-testing a conduit, or said sealing door when connecting the conduit with another conduit in a fluid communication.

61. The leak testing device of claim 60, wherein:
a) said sealing door includes a through hole and a sealing portion.

62. The leak testing device of claim 61, wherein:
a) the diameter of the through hole in said sealing door generally corresponds to the internal diameter of the end portion of the conduit.

63. A method of testing for a leak in a conduit, comprising:
a) providing a first conduit to be leak-tested;
b) providing a second conduit;
c) providing a leak testing device between the end portions of the first and second conduits, wherein the leak testing device comprises:
i) a generally cylindrical body defining a recess therethrough;
ii) the body including first and second end portions for cooperating with the respective end portions of two adjacent conduits;
iii) the body including an opening between the first and second end portions;
iv) a sealing door to be positioned in the opening;
v) a diaphragm member to be positioned within the body;
vi) the diaphragm member including a through hole;
vii) a valve operably connected to the diaphragm member for selectively opening or closing the through hole to thereby permit or restrict the flow of a fluid between the conduits; and
viii) the opening in the body receiving the diaphragm member when leak-testing a conduit, or the sealing door when connecting two conduits in a fluid communication;
d) positioning the diaphragm in the recess through the opening;
e) actuating the valve to restrict the flow of fluid between the first and second conduits;
f) filling the first conduit with a fluid;
g) inspecting the first conduit for any leaks; and
h) actuating the valve to permit the flow of fluid from the first conduit to the second conduit.

64. The method of claim 63, further comprising:
i) removing the diaphragm from the recess; and
j) positioning the sealing door in the opening.

65. A method of testing for a leak in a conduit, comprising:
a) providing a first conduit to be leak-tested;
b) providing a second conduit;
c) providing a leak testing device between the end portions of the first and second conduits, wherein the leak testing device comprises:
i) a generally cylindrical body defining a recess therethrough;
ii) the body including first and second end portions for cooperating with the respective end portions of two adjacent conduits;
iii) the body including an opening between the first and second end portions;
iv) the body including a trough disposed generally opposite the opening;
v) a sealing door to be positioned in the opening;
vi) a diaphragm member to be positioned within said body;
vii) the diaphragm member including a through hole;
viii) a valve operably connected to the diaphragm member for selectively opening or closing the through hole to thereby permit or restrict the flow of a fluid between the conduits; and
ix) the opening in the body receiving the diaphragm member when leak-testing a conduit, or said sealing door when connecting two conduits in a fluid communication;
d) positioning the diaphragm in the recess through the opening;
e) actuating the valve to restrict the flow of fluid between the first and second conduits;
f) filling the first conduit with a fluid;
g) inspecting the first conduit for any leaks; and
h) actuating the valve to permit the flow of fluid from the first conduit to the second conduit.

66. The method of claim 65, further comprising:
i) removing the diaphragm from the recess; and
j) positioning the sealing door in the opening.

67. A method of testing for a leak in a conduit, comprising:
a) providing a conduit to be leak-tested;
b) providing a leak testing device adjacent an end portion of the conduit, wherein the leak testing device comprises:
i) a generally cylindrical body defining a recess therethrough;
ii) the body including an end portion for cooperating with an end portion of a conduit;
iii) the body including an opening about the circumference thereof and in communication with the recess;
iv) a sealing door to be positioned in the opening;
v) a diaphragm member to be positioned within the body;
vi) the diaphragm member including a through hole;
vii) a valve operably connected to the diaphragm member for selectively opening or closing the through hole to thereby permit or restrict the flow of a fluid therethrough; and
viii) the opening in the body receiving the diaphragm member when leak-testing a conduit, or the sealing door when connecting the conduit with another conduit in a fluid communication;
c) positioning the diaphragm in the recess through the opening;
d) actuating the valve to restrict the flow of fluid through the hole;
e) filling the conduit with a fluid;
f) inspecting the conduit for any leaks; and
g) actuating the valve to permit the flow of fluid through the hole.

68. The method of claim 67, further comprising:
h) removing the diaphragm from the recess; and
i) positioning the sealing door in the opening.

69. A method of testing for a leak in a conduit, comprising:
a) providing a conduit to be leak-tested;
b) providing a leak testing device adjacent an end portion of the conduit, wherein the leak testing device comprises:
i) a generally cylindrical body defining a recess therethrough;
ii) the body including an end portion for cooperating with an end portion of a conduit;
iii) the body including an opening about the circumference thereof and in communication with the recess;
iv) the body including a trough disposed generally opposite the opening;
v) a sealing door to be positioned in the opening;
vi) a diaphragm member to be positioned within the body;
vii) the diaphragm member including a through hole;
viii) a valve operably connected to the diaphragm member for selectively opening or closing the through hole to thereby permit or restrict the flow of a fluid therethrough; and
ix) the opening in the body receiving the diaphragm member when leak-testing a conduit, or the sealing door when connecting the conduit with another conduit in a fluid communication;
c) positioning the diaphragm in the recess through the opening;
d) actuating the valve to restrict the flow of fluid through the hole;
e) filling the conduit with a fluid;
f) inspecting the conduit for any leaks; and
g) actuating the valve to permit the flow of fluid through the hole.

70. The method of claim 69, further comprising:
h) removing the diaphragm from the recess; and
i) positioning the sealing door in the opening.
